(19) United States
(12) Patent Application Publication
(10) Pub. No.: US 2022/0397151 A1
(43) Pub. Date: Dec. 15, 2022

(54) DYNAMIC PRESSURE BEARING STRUCTURE WITH DOUBLE BEVELED EDGES

(71) Applicant: TUNG PEI INDUSTRIAL CO.,LTD., Taipei City (TW)

(72) Inventors: YU-YUEH CHEN, TAOYUAN COUNTY (TW); CHING-HUI YU, Taoyuan City (TW)

(21) Appl. No.: 17/412,531

(22) Filed: Aug. 26, 2021

(30) Foreign Application Priority Data
Jun. 11, 2021 (TW) 110121323

(51) Int. Cl. F16C 17/02

(52) U.S. Cl. CPC F16C 17/026

(57) ABSTRACT

A dynamic pressure bearing structure with double beveled edges is provided. The dynamic pressure bearing structure includes a bearing body, a shaft hole, and at least one oil guiding groove group. The shaft hole is disposed inside the bearing body and passes through two ends of the bearing body. The oil guiding groove group is arranged on an inner wall of the shaft hole. Two beveled edge portions are disposed on outer walls of the bearing body and forms an air escape structure. An outer diameter of the bearing body, an inner diameter of the shaft hole, and a height of the bearing body form an optimized size, with a thinnest position having a thickness being greater than or equal to 0.01 mm. The dynamic pressure bearing structure is manufactured using a metal cutting process or a powder metallurgy process.

### CROSS-REFERENCE TO RELATED PATENT APPLICATION

This application claims the benefit of priority to Taiwan Patent Application No. 110121323, filed on Jun. 11, 2021. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a dynamic pressure bearing structure with double beveled edges, and more particularly to a bearing structure that allows fluids to flow between a bearing and a shaft, in which a pressure field is generated from changes in flowing velocity of the fluids so that the shaft can be stably spun without coming in contact with the bearing.

### BACKGROUND OF THE DISCLOSURE

A conventional dynamic pressure bearing has oil guiding grooves arranged on an inner wall of a bearing body or an outer wall of a shaft, and a lubricating fluid is converged to form a pressure when the lubricating fluid flows between the shaft and the bearing body. Due to a supporting force of an oil film, the shaft does not contact sides of a shaft hole when the shaft spins, such that the shaft is prevented from colliding with the bearing body, thereby avoiding wear and reducing noise and vibration. The conventional dynamic pressure bearing is nowadays often adopted in consumer electronics. However, an air escape space for allowing air to escape therethrough is limited in the conventional dynamic pressure bearing. Therefore, when the conventional dynamic pressure bearing is installed in a motor, hot air is difficult to be discharged, so that the performance of the motor is also limited.

### SUMMARY OF THE DISCLOSURE

In response to the above-referenced technical inadequacy, the present disclosure provides a dynamic pressure bearing structure with double beveled edges so as to increase an air escape space and facilitate discharging of hot air.

In one aspect, the present disclosure provides a dynamic pressure bearing structure with double beveled edges, the dynamic pressure bearing structure includes a bearing body, a shaft hole, at least one oil guiding groove group, a first beveled edge portion, and a second beveled edge portion. The shaft hole is disposed inside the bearing body and passes through two ends of the bearing body. The oil guiding groove group is arranged on an inner wall of the shaft hole and includes a plurality of oil guiding grooves. Each of the oil guiding grooves is in a shape of the letter “V”. The first beveled edge portion is arranged on an outer wall of the bearing body. The first beveled edge portion is a flat surface, and a minimal distance between the first beveled edge portion and the inner wall of the shaft hole is greater than or equal to 0.01 mm. The second beveled edge portion is arranged on the outer wall of the bearing body. The second beveled edge portion is a flat surface, and a minimal distance between the second beveled edge portion and the inner wall of the shaft hole is greater than or equal to 0.01 mm.

In a preferred embodiment, the minimal distance between the first beveled edge portion and the inner wall of the shaft hole is from 0.02 mm to 0.08 mm, and the minimal distance between the second beveled edge portion and the inner wall of the shaft hole is from 0.02 mm to 0.08 mm.

In a preferred embodiment, an outer diameter of the bearing body is from 3 mm to 8 mm, an inner diameter of the shaft hole is from 1 mm to 3 mm, and a height of the bearing body is from 1 mm to 13 mm.

In a preferred embodiment, the outer diameter of the bearing body is from 3 mm to 5 mm, the inner diameter of the shaft hole is 1.5 mm, and the height of the bearing body is from 1 mm to 5 mm.

In a preferred embodiment, the outer diameter of the bearing body is from 3 mm to 5 mm, the inner diameter of the shaft hole is 2 mm, and the height of the bearing body is from 1 mm to 7 mm. In a preferred embodiment, the outer diameter of the bearing body is from 7 mm to 8 mm, the inner diameter of the shaft hole is 3 mm, and the height of the bearing body is from 5 mm to 13 mm.

In a preferred embodiment, the outer diameter of the bearing body is from 3 mm to 5 mm, the inner diameter of the shaft hole is 1 mm, and the height of the bearing body is from 1 mm to 3 mm.

One of the advantageous effects of the present disclosure is that, the dynamic pressure bearing structure with double beveled edges provided by the present disclosure includes a bearing body, a shaft hole, at least one oil guiding groove group, a first beveled edge portion, and a second beveled edge portion. The shaft hole is disposed inside the bearing body. The oil guiding groove group is arranged on the inner wall of the shaft hole. The first beveled edge portion and the second beveled edge portion are arranged on the outer wall of the bearing body. The first beveled edge portion and the second beveled edge portion both are flat surfaces. The minimal distance between the first beveled edge portion and the inner wall of the shaft hole is greater than or equal to 0.01 mm, and the minimal distance between the second beveled edge portion and the inner wall of the shaft hole is greater than or equal to 0.01 mm. In the present disclosure, the first beveled edge portion and the second beveled edge portion are arranged on the outer wall of the bearing body to form a double beveled edge structure, such that the air escape space is increased and good air escaping effect is achieved to facilitate discharging of hot air and maintaining sufficient structural strength.

Preferably, the outer diameter of the bearing body is from 3 mm to 8 mm, the inner diameter of the shaft hole is from 1 mm to 3 mm, and the height of the bearing body is from 1 mm to 13 mm. The outer diameter of the bearing body, the inner diameter of the shaft hole, and the height of the bearing body can be adequately adjusted to define an optimal size for enabling the dynamic pressure bearing structure to have a predetermined strength and bearing effect.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a perspective view of a dynamic pressure bearing structure with double beveled edges according to a first embodiment of the present disclosure;

FIG. 2 a top view of the dynamic pressure bearing structure with the double beveled edges according to the first embodiment of the present disclosure;

FIG. 3 is a cross-sectional view taken along line III-III of FIG. 2;

FIG. 4 is a cross-sectional view of the dynamic pressure bearing structure with the double beveled edges according to a second embodiment of the present disclosure;

FIG. 5 is a top view of the dynamic pressure bearing structure with the double beveled edges according to a third embodiment of the present disclosure; and

FIG. 6 is a top view of the dynamic pressure bearing structure with the double beveled edges according to a fourth embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### EMBODIMENTS

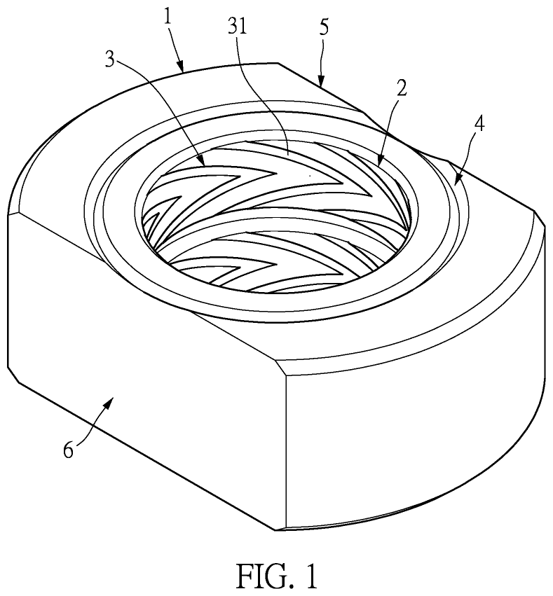

Referring to FIG. 1 to FIG. 3, the present disclosure provides a dynamic pressure bearing structure with double beveled edges, and the dynamic pressure bearing structure includes a bearing body 1, a shaft hole 2, and at least one oil guiding groove group 3.

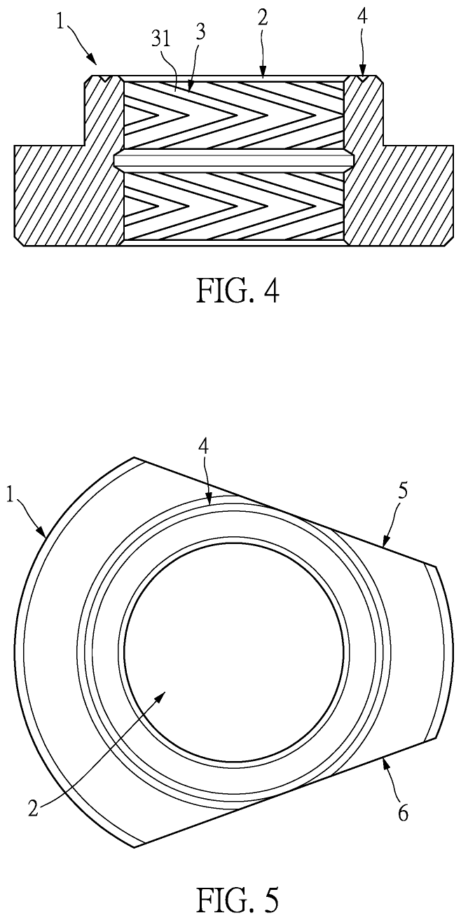

The bearing body 1 substantially is a hollow cylinder, and diameters at different positions of an outer wall (i.e., an outer surface) of the bearing body 1 can be equal or unequal. In this embodiment, the diameters at different positions of the outer wall of the bearing body 1 are equal to each other. On the other hand, as shown in FIG. 4, the diameters at different positions of the outer wall of the bearing body 1 can be unequal to each other, e.g., a diameter at a lower portion of the outer wall of the bearing body 1 is greater than a diameter at an upper portion of the outer wall of the bearing body 1.

The shaft hole 2 is disposed inside the bearing body 1. The shaft hole 2 is a circular hole, and passes through two ends of the bearing body 1, so as to be matched with a shaft.

The oil guiding groove group 3 is arranged on an inner wall (i.e., an inner surface) of the shaft hole 2, and the oil guiding groove group 3 includes a plurality of oil guiding grooves 31. Each of the oil guiding grooves 31 is in a shape of the letter “V”, and can be equidistantly spaced apart from each other. The oil guiding grooves 31 can be used to guide a lubrication fluid such that the lubrication fluid flows between the shaft and the bearing body 1, and the lubrication fluid is converged to form a pressure. The shaft does not contact the shaft hole 2 when the shaft spins due to a supporting force of an oil film, such that the shaft is prevented from colliding with the bearing body 1, thereby avoiding wear and reducing noise and vibration. Since the aforementioned dynamic pressure bearing structure is of the conventional technology, further descriptions relating thereto will not be provided herein.

In this embodiment, one end of the bearing body 1 or the outer wall of the bearing body 1 can further have at least one identification mark 4 provided thereon. The identification mark 4 is essentially visible to the naked eye. A quantity of the identification mark 4 can be one or more, the identification mark 4 can be a concave structure, a convex structure or a pattern structure, etc., and the identification mark 4 can be in an annular, segmented or dotted arrangement, but it is not limited thereto. In this embodiment, the identification mark 4 is a concave structure and in an annular arrangement. The identification mark 4 can provide an identification function, and can be used to identify a direction of the oil guiding groove 31 (a forward direction or a reverse direction), so as to facilitate assembly and prevent the same from being installed backwards. The identification mark 4 can also provide for brand identification for identifying the manufacturer.

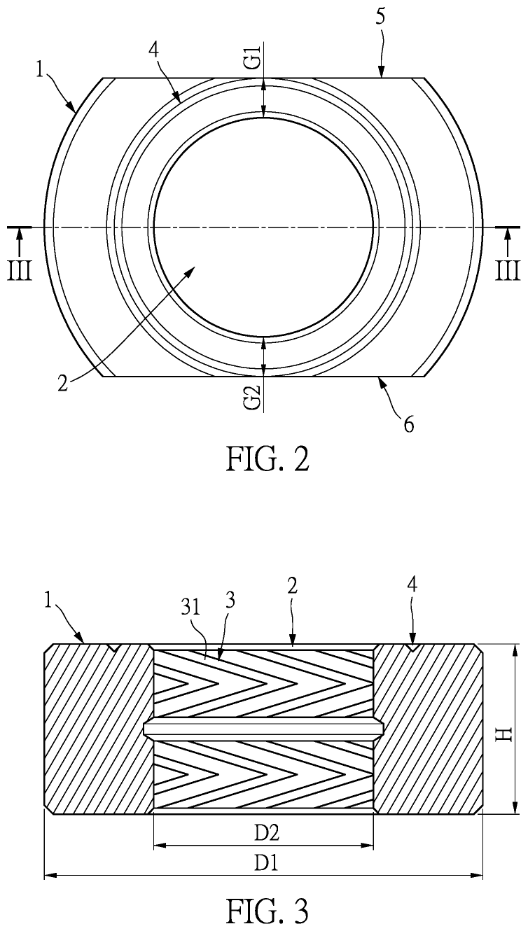

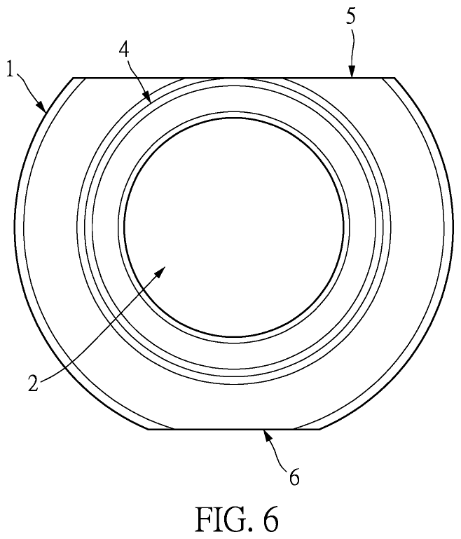

A first beveled edge portion 5 and a second beveled edge portion 6 are arranged on the outer wall (i.e., the outer surface) of the bearing body 1. The first beveled edge portion 5 and the second beveled edge portion 6 can be arranged on two sides of the outer wall of the bearing body 1. The first beveled edge portion 5 and the second beveled edge portion 6 are both flat surfaces. The dynamic pressure bearing structure can be made by using a metal cutting process or a powder metallurgy process, etc., so as to form the first beveled edge portion 5 and the second beveled edge portion 6, such that an air escape structure is formed. When the dynamic pressure bearing structure is installed in a motor, an air escape space can be effectively increased for discharging hot air. The first beveled edge portion 5 and the second beveled edge portion 6 can be parallel (as shown in FIGS. 2 and 6) or non-parallel to each other (as shown in FIG. 5), and the first beveled edge portion 5 and the second beveled edge portion 6 can be symmetrical (as shown in FIGS. 2 and 5) or asymmetrical to each other (as shown in FIG. 6). Such parallel or symmetrical arrangements between the first beveled edge portion 5 and the second beveled edge portion 6 can be varied and are not limited in the present disclosure, and variations of such arrangements can be chosen according to practical requirements.

An outer diameter D1 of the bearing body 1, an inner diameter D2 of the shaft hole 2, and a height H of the bearing body 1 can define an optimal size for enabling the dynamic pressure bearing structure to provide a predetermined strength and bearing effect. Preferably, the outer diameter D1 of the bearing body 1 is from 3 mm to 8 mm, and the outer diameter D1 of the bearing body 1 can be 3 mm, 5 mm, 7 mm, or 8 mm, etc. The inner diameter D2 of the shaft hole 2 is from 1 mm to 3 mm, and the inner diameter D2 of the shaft hole 2 can be 1 mm, 1.5 mm, 2 mm, or 3 mm, etc. The height H of the bearing body 1 is from 1 mm to 13 mm, and the height H of the bearing body 1 can be 1 mm, 3 mm, 5 mm, 7 mm, or 13 mm, etc.

Preferably, when the outer diameter D1 of the bearing body 1 is from 3 mm to 5 mm, the inner diameter D2 of the shaft hole 2 is 1.5 mm, and the height H of the bearing body 1 is from 1 mm to 5 mm. When the outer diameter D1 of the bearing body 1 is from 3 mm to 5 mm, the inner diameter D2 of the shaft hole 2 is 2 mm, and the height H of the bearing body 1 is from 1 mm to 7 mm. When the outer diameter D1 of the bearing body 1 is from 7 mm to 8 mm, the inner diameter D2 of the shaft hole 2 is 3 mm, and the height H of the bearing body 1 is from 5 mm to 13 mm. When the outer diameter D1 of the bearing body 1 is from 3 mm to 5 mm, the inner diameter D2 of the shaft hole 2 is 1 mm, and the height H of the bearing body 1 is from 1 mm to 3 mm. The height H of the bearing body 1 is a length of the bearing body 1 along an axial direction of the bearing body 1, that is, a distance between two ends of the bearing body 1.

Furthermore, a thickness of a thinnest position on the bearing body 1 is not smaller than 0.01 mm, that is, the thickness of the thinnest position on the bearing body 1 is greater than or equal to 0.01 mm, and the thickness of the thinnest position on the bearing body 1 preferably is from 0.02 mm to 0.08 mm, such that the bearing body can maintain sufficient strength, and have good air escaping effect. Specifically, a minimal distance G1 between the first beveled edge portion 5 and the inner wall of the shaft hole 2 is greater than or equal to 0.01 mm, preferably, the minimal distance G1 between the first beveled edge portion 5 and the inner wall of the shaft hole 2 is from 0.2 mm to 0.8 mm, and the minimal distance G1 between the first beveled edge portion 5 and the inner wall of the shaft hole 2 can exemplarily be 0.02 mm, 0.03 mm, 0.04 mm, 0.05 mm, 0.06 mm, 0.07 mm, or 0.08 mm. The minimal distance G1 between the first beveled edge portion 5 and the inner wall of the shaft hole 2 is a distance between the first beveled edge portion 5 and the inner wall of the shaft hole 2 along a diameter direction of the bearing body 1. A minimal distance G2 between the second beveled edge portion 6 and the inner wall of the shaft hole 2 is greater than or equal to 0.01 mm, preferably, the minimal distance G2 between the second beveled edge portion 6 and the inner wall of the shaft hole 2 is from 0.2 mm to 0.8 mm, and the minimal distance G2 between the second beveled edge portion 6 and the inner wall of the shaft hole 2 can exemplarily be 0.02 mm, 0.03 mm, 0.04 mm, 0.05 mm, 0.06 mm, 0.07 mm, or 0.08 mm. The minimal distance G2 between the second beveled edge portion 6 and the inner wall of the shaft hole 2 is a distance between the second beveled edge portion 6 and the inner wall of the shaft hole 2 along another diameter direction of the bearing body 1.

### Beneficial Effects of the Embodiments

One of the advantageous effects of the present disclosure is that, the dynamic pressure bearing structure with double beveled edges provided by the present disclosure includes the bearing body, the shaft hole, the at least one oil guiding groove group, the first beveled edge portion, and the second beveled edge portion. The shaft hole is disposed inside the bearing body. The oil guiding groove group is arranged on the inner wall of the shaft hole. The first beveled edge portion and the second beveled edge portion are arranged on the outer wall of the bearing body. The first beveled edge portion and the second beveled edge portion both are flat surfaces. The minimal distance between the first beveled edge portion and the inner wall of the shaft hole is greater than or equal to 0.01 mm, and the minimal distance between the second beveled edge portion and the inner wall of the shaft hole is greater than or equal to 0.01 mm. In the present disclosure, the first beveled edge portion and the second beveled edge portion are arranged on the outer wall of the bearing body to form the double beveled edge structure, such that the air escape space is increased and good air escaping effect is achieved to facilitate discharging of hot air and maintaining sufficient structural strength.

Furthermore, the outer diameter of the bearing body is from 3 mm to 8 mm, the inner diameter of the shaft hole is from 1 mm to 3 mm, and the height of the bearing body is from 1 mm to 13 mm. The outer diameter of the bearing body, the inner diameter of the shaft hole, and the height of the bearing body can be adequately adjusted to define an optimal size for enabling the dynamic pressure bearing structure to have a predetermined strength and bearing effect.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A dynamic pressure bearing structure with double beveled edges, comprising:
a bearing body;
a shaft hole disposed inside the bearing body and passing through two ends of the bearing body;
at least one oil guiding groove group arranged on an inner wall of the shaft hole, and the oil guiding groove group including a plurality of oil guiding grooves, wherein each of the oil guiding grooves is in a shape of the letter “V”;
a first beveled edge portion arranged on an outer wall of the bearing body, wherein the first beveled edge portion is a flat surface, and a minimal distance between the first beveled edge portion and the inner wall of the shaft hole is greater than or equal to 0.01 mm; and
a second beveled edge portion arranged on the outer wall of the bearing body, wherein the second beveled edge portion is a flat surface, and a minimal distance between the second beveled edge portion and the inner wall of the shaft hole is greater than or equal to 0.01 mm.

2. The dynamic pressure bearing structure according to claim 1, wherein a minimal distance between the first beveled edge portion and the inner wall of the shaft hole is from 0.02 mm to 0.08 mm, and a minimal distance between the second beveled edge portion and the inner wall of the shaft hole is from 0.02 mm to 0.08 mm.

3. The dynamic pressure bearing structure according to claim 1, wherein one of the two ends of the bearing body or the outer wall of the bearing body has at least one identification mark provided thereon, and the at least one identification mark provides an identification function.

4. The dynamic pressure bearing structure according to claim 1, wherein the first beveled edge portion and the second beveled edge portion are parallel or non-parallel to each other.

5. The dynamic pressure bearing structure according to claim 1, wherein the first beveled edge portion and the second beveled edge portion are symmetrical or asymmetrical to each other.

6. The dynamic pressure bearing structure according to claim 1, wherein an outer diameter of the bearing body is from 3 mm to 8 mm, an inner diameter of the shaft hole is from 1 mm to 3 mm, and a height of the bearing body is from 1 mm to 13 mm.

7. The dynamic pressure bearing structure according to claim 1, wherein an outer diameter of the bearing body is from 3 mm to 5 mm, an inner diameter of the shaft hole is 1.5 mm, and a height of the bearing body is from 1 mm to 5 mm.

8. The dynamic pressure bearing structure according to claim 1, wherein an outer diameter of the bearing body is from 3 mm to 5 mm, an inner diameter of the shaft hole is 2 mm, and a height of the bearing body is from 1 mm to 7 mm.

9. The dynamic pressure bearing structure according to claim 1, wherein an outer diameter of the bearing body is from 7 mm to 8 mm, an inner diameter of the shaft hole is 3 mm, and a height of the bearing body is from 5 mm to 13 mm.

10. The dynamic pressure bearing structure according to claim 1, wherein an outer diameter of the bearing body is from 3 mm to 5 mm, an inner diameter of the shaft hole is 1 mm, and a height of the bearing body is from 1 mm to 3 mm.
